(19) United States
(12) Patent Application Publication
(10) Pub. No.: US 2008/0288410 A1
(43) Pub. Date: Nov. 20, 2008

(54) Content Distribution System

(76) Inventor: Yuichi Nino, Tokyo (JP)

Correspondence Address: FOLEY AND LARDNER LLP;SUITE 500, 3000 K STREET NW, WASHINGTON, DC, 20007, US

(21) Appl. No.: 11/658,262

(22) PCT Filed: Oct. 4, 2005
(86) PCT No.: PCT/JP05/18362

§ 371 Date: Jan. 24, 2007

(30) Foreign Application Priority Data
Oct. 6, 2004 (JP) 2004-294249

(51) Int. Cl. H04L 9/32; G06Q 10/00; G06Q 30/00

(52) U.S. Cl. 705/52; 705/58

(57) ABSTRACT

A content distribution method is provided that restricts content distribution means to a specific distribution method and traces a content distribution route in the specific distribution method, without any leakage, even when a user who does not reproduce contents on the way exists. The content distribution system primarily encrypts contents to distribute them from the server. When contents are distributed between terminals, a transmission terminal registers an encryption key for communication encryption in a server. A reception terminal captures the encryption key from the server. Thus, the server saves the content distribution route. Moreover, each terminal accesses the server to reproduce the contents. When the server verifies that the contents have been distributed to the terminal, the server issues the content reproduction key.

### TECHNICAL FIELD

The present invention relates to a content distribution system, a content distribution method, and a content distribution program. Particularly, the present invention relates to a content distribution system, a content distribution method, and a content distribution program, each which is capable of tracing content distribution routes.

### BACKGROUND ART

Recently, peer-to-peer (P2P) distribution software, such as Napster, Gnutella, and Winny, which distribute contents among personals, has become widespread. With a widespread use of such distribution software, the opportunity is now increasing that users not only download directly contents from a content distribution server but also directly exchange contents between them. Monitoring whether or not how contents are distributed by using the P2P software is very useful for marketing because it can be grasped whether or not certain contents are liked to what type of user bases or what type of users recommend their favorite contents to others.

The content distribution system, disclosed in the patent document 1, may be provided as a method for grasping such content distribution status.

The conventional content distribution system, as shown in FIG. 7, includes a server 1 and terminals 2a, 2b, and 2c. The server 1, as shown in FIG. 8, is configured of a user information database 10, a content database 11, a web server 12, a user information manager 13, an encryption unit 14, and a content distribution status analyzer 15.

This conventional content distribution system operates as follows:

That is, the user information database 10, as shown in FIG. 9, stores a user ID, a terminal ID, user information, a name of content, a recommendation ID representing an introducer of a corresponding content or a person who has transmitted the content, and a name of a reproduction program for reproducing contents. The contents database 11 stores contents to be distributed and a reproduction program for them. When contents are used, a content user (for example, the user A shown in FIG. 7) uses his terminal (2a) to register his user information 6a via the web server 12. The user information 6a includes at least a user ID (ID-A), a terminal ID specifying a terminal, user information about such as name and contact address, and a content name desired by the user.

The user information manager 13 saves the above-mentioned information in the user information database 10.

As to the content required by the user A, the encryption unit 14 transmits the content 5, in which a user ID (ID-A) of the user A is embedded, to the terminal 2a. The terminal 2a requires the server 1 to send a reproduction program for reproducing contents.

In response to the request, the encryption unit 14 encrypts the reproduction program in the contents database 11 using an encryption key, based on user information on the user A and based on at least one of information on a content name and an encoding string of the content, and then transmits the reproduction program 7a. The terminal A decodes the reproduction program 7a using a decryption key based on the user information on the user A and based on at least one of the information on a content name and the encoding string of the content and thus reproduces the content.

Next, when the user A introduces the content to the user B, the user A operates as follows:

First, the user A transmits the content 5 to the terminal 2b of the user B, using, for example, a local connection or the P2P file shared software.

The terminal 2b cannot reproduce the content 5 without any change. For that reason, to capture a reproduction program, the terminal 2b urges the user B to register his user information in the server 1. The user B registers the user information 6b via the web server 12. As to the user information 6b, the user ID (ID-A) embedded in the content 5 is transmitted to the server 1, together with the user information 6a.

The user information manager 13 in the server 1 saves ID-A as a recommendation ID, in agreement with a user ID (ID-B), a terminal ID, user information, and a content name, which have been transmitted.

The encryption unit 14 encrypts a reproduction program in the content database 11, using an encryption key based on the user information of the user B and at least one of information on a content name and an encoding string of a content, and then transmits the encrypted reproduction program 7b.

The terminal 2b decodes the reproduction program 7a using a decryption key based on the user information of the user A and based on at least one of information on a content name and an encoding string of a content and thus reproduces the content.

Even when the user B introduces the user C, the above mentioned procedure is carried out if the user C views the content. In this case, the recommendation ID of the user ID (ID-C) of the user C is saved as ID-A in the user information database.

[Patent Document 1]

JP-P2004-12866A

### DISCLOSURE OF THE INVENTION

### Problems to be Solved by the Invention

The following problems may occur in the above-mentioned conventional method.

Though a content is distributed in the form of user A→user B→user C, the user information database 10 saves the content only in the form of user A→user B and user A→user C, as shown in FIG. 9. Therefore, the first problem is that the true distribution route cannot be grasped.

That reason is that the ID of the user ID, which has first downloaded the content, is embedded in the content and that the introducer is registered in the server based on the ID in subsequent distributions.

In the second problem, when a content is handed over to another user without reproducing the content, the user information is not registered in the server. Hence, the marketing information on which to what bases of users the corresponding content have been not accepted cannot be collected.

That reason is that the user who has not reproduced the content does not access the server 1 to capture the reproduction program.

The present invention is made to solve the above-mentioned problems. An object of the present invention is to provide a content distribution system capable of tracking all distribution routes for contents distributed by a specific distribution method.

Another object of the present invention is to provide a content distribution system capable of tracking content distribution routes even when contents are not reproduced.

Further another object of the present invention is to provide a content distribution system capable of limiting content distributions to a specific distribution method.

### Means to Solve the Problems

In order to solve the above-mentioned problems, a content distribution system in an aspect of the present invention comprises means for distributing a content encrypted; means for saving a reproduction key for decoding the encrypted content; means for creating an encryption key for communications when the encrypted content is transmitted and received between terminals, and for registering in a server the encryption key, an ID for the content, an ID for a transmission source terminal, and an ID for a transmission destination terminal; means for transmitting a doubly encrypted content to the transmission destination terminal, the doubly encrypted content being obtained by doubly encrypting an encrypted content using the encryption key; means for transmitting a transmission request after reception of the doubly encrypted content, together with the content ID and the transmission destination terminal ID, and the transmission source terminal ID, the transmission request requesting transmission of the encryption key; means for checking the content ID, the transmission source terminal ID, and the transmission destination terminal ID, each registered, against the content ID, the transmission destination terminal ID, and the transmission source terminal ID, each transmitted together with the transmission request, and for transmitting a registered encryption key to the transmission destination terminal if there is a match; distribution management means for saving the content ID, the transmission source terminal ID, and the transmission destination terminal ID, each registered; means for requesting transmission of the reproduction key to reproduce the content; and reproduction key transmission means for transmitting the reproduction key when a terminal, which has requested the reproduction key, corresponds to a terminal registered in the distribution management means.

In the content distribution system, the reproduction key transmission means includes means for referring to information registered in the distribution management means and for performing discount billing in accordance with the number of distributions when a user of a terminal requesting transmission of a reproduction key has distributed a lot of contents in past.

In another aspect of the present invention, a content distribution method comprises steps of distributing an encrypted content; saving a reproduction key which decodes the encrypted content; creating an encryption key for communication when the encrypted content is transmitted and received between terminals and registering in a server the encryption key and the content ID, the transmission source terminal ID, and the transmission destination terminal ID; transmitting the doubly encrypted content, in which the encrypted content is doubly encrypted with the encryption key, from the transmission source terminal to the transmission destination terminal; after reception of the doubly encrypted content, transmitting a transmission request for the encryption key to the server, together with the content ID, the transmission destination terminal ID, and the transmission source terminal ID; checking the content ID, the transmission source terminal ID, and the transmission destination terminal ID, each registered, against the content ID, the transmission destination terminal ID, and the transmission source terminal ID, transmitted together with the transmission request, and then transmitting an encryption key, registered, to the transmission destination terminal when there is a match; performing distribution management where the content ID, the transmission source terminal ID, and the transmission destination terminal ID, each registered, are saved; requiring transmission of the reproduction key to reproduce the content; and performing reproduction key transmission where the reproduction key is transmitted when a terminal requesting the reproduction key corresponds to a terminal registered in the distribution management means.

In the content distribution method, the reproduction key transmission step comprises steps of referring to information registered in the distribution management step; and performing reduction billing in accordance with the number of distributions when the reference exhibits the fact that a user of a terminal requesting transmission of a reproduction key distributed in past a lot of contents.

In another aspect of the present invention, a program is provided for directing a computer to execute the steps of distributing a content encrypted; saving a reproduction key that decodes the encrypted content; creating an encryption key for communication when the encrypted content is transmitted and received between terminals and registering to a server the encryption key, an ID for the content, an ID for a transmission source terminal, and an ID for a transmission destination terminal; transmitting a doubly encrypted content, in which an encrypted content is doubly encrypted with the encryption key, to the transmission destination terminal; after the doubly encryption content is received, transmitting a transmission request, which requires transmission of the encryption key together with the content ID, the transmission destination terminal ID, and the transmission source terminal ID; checking the content ID, the transmission source terminal ID, and the transmission destination terminal ID, each registered, against the content ID, the transmission destination terminal ID, and the transmission source terminal ID, transmitted together with the transmission request and then transmitting the registered encryption key to the transmission destination terminal when there is a match; performing a distribution management process for saving the content ID, the transmission source terminal ID, and the transmission destination terminal ID, each registered; requiring transmission of the reproduction key to reproduce the content; and performing a reproduction key transmission process for transmitting the reproduction key when a terminal requiring the reproduction key corresponds to a terminal registered in the distribution management means.

In the content distribution method, the reproduction key transmission process directs a computer to execute the steps of referring to information registered in the distribution management process; performing reduction billing according to the number of distributions when a user of a terminal requiring a reproduction key distributed in past a lot of contents.

In another aspect of the present invention, a terminal comprises means for creating a communication key when an encrypted content is transmitted to another terminal and transmitting the communication key, an ID of an encrypted content, an ID of a transmission source terminal, and an ID of a transmission destination terminal; means for creating a doubly encrypted content, in which an encrypted content is doubly encrypted with the communication key; means for transmitting the doubly encrypted content; means for receiving the doubly encrypted content; when a transmission request for transmission of the communication key is transmitted, means for transmitting the encrypted content ID, the transmission source terminal ID, and the transmission destination terminal ID; means receiving a communication key transmitted in accordance with a transmission request for the communication key and decoding the doubly encrypted content; means for requiring transmission of the reproduction key to reproduce the decoded content; and means for receiving a reproduction key transmitted in accordance with a transmission request for the reproduction key and reproducing the content.

In another aspect of the present invention, a server comprises means for saving an ID of an encrypted content and a reproduction key to decode the encrypted content ID; means for receiving a communication key, the encrypted content ID, a transmission source terminal ID, and a transmission destination terminal ID, from a transmission source terminal; means for receiving a communication key transmission request, the encrypted content ID, a transmission source terminal ID, and a transmission destination terminal ID, from a transmission destination terminal; means for subjecting the content ID, the transmission source terminal ID, and the transmission destination terminal ID, received by the two means, to verification and then transmitting the communication key to the transmission destination terminal when there is a match; means for registering the encrypted content ID, the transmission source terminal ID and the transmission destination terminal ID in a database; and means for verifying, when a transmission request for the reproduction key has come from a transmission destination terminal, whether or not the terminal is in the database and transmitting the reproduction key when the corresponding terminal is in the database.

In the server, the reproduction key transmission means includes means for referring to information registered in the database and performing reduction billing in accordance with the number of distributions when a user of a terminal requesting a reproduction key distributed in past a lot of contents.

In another aspect of the present invention, a content distribution system comprises means for encrypting a content before the content is transmitted, creating an encryption key to decode the encrypted content, and registering identification information for identifying the encryption key and the content, identification information on a transmission source terminal, and identification information on a transmission destination terminal; means for transmitting to a transmission destination terminal identification information identifying the encrypted content and the content and identification information on a transmission source terminal; and means for checking identification information on the content, identification information on a transmission source terminal, and identification information on a transmission destination terminal, each received, against identification information on the content, identification information on a transmission source terminal, and identification information on a transmission destination terminal, each registered, and transmitting to the encryption key to a transmission destination terminal when there is a match.

Distribution routes are managed based on the identification information on the content, the identification information on a transmission source terminal, and the identification information on a transmission destination terminal, each registered.

In another aspect of the present invention, a terminal comprises means for encrypting a content when the content is transmitted, creating an encryption key to decode the encrypted content, and transmitting the encryption key, identification information identifying the content, identification information on a transmission source terminal, and identification information on a transmission destination terminal; means for transmitting the encrypted content, identification information identifying the content, and identification information on a transmission source terminal, to a transmission destination terminal.

Distribution routes are registered based on identification information identifying the transmitted content, identification information on a transmission source terminal, and identification information on a transmission destination terminal.

In another aspect of the present invention, a server comprises means for receiving an encryption key for decoding an encrypted content, identification information on the encrypted content, identification information on a transmission source terminal which transmits the encrypted content, and identification information on a transmission destination terminal; means for checking, when a transmission request for the encryption key is received, content identification information, transmission source terminal identification information, and transmission destination terminal identification information, to be transmitted together with the transmission request for the encryption key, against the content identification information, the transmission source terminal identification information and the transmission destination terminal identification information, each received, and then transmitting the encryption key when there is a match; whereby distribution routes are recorded based on the content identification information, the transmission source terminal identification information, and the transmission destination terminal identification terminal, each received.

In another aspect of the present invention, a content distribution method comprises the steps of encrypting a content when the content is transmitted; creating an encryption key to decode the encrypted content; registering identification information for identifying the encryption key and the content, transmission source terminal identification information, and transmission destination terminal identification information; transmitting the encrypted content, identification information for identifying the content and the transmission source terminal identification information to a transmission destination terminal; and checking the content identification information, the transmission source terminal identification information, and the transmission destination terminal identification information, each received, against content identification information, transmission source terminal identification information, and transmission destination terminal identification information, each registered, and transmitting the encryption key to a transmission destination terminal when there is a match.

In another aspect of the present invention, a program for a terminal directs a terminal to function as means for encrypting a content when the content is transmitted, creating an encryption key to decode the encrypted content, and transmitting the encryption key, identification information for identifying the content, transmission source terminal identification information, and transmission destination terminal identification information; and means for transmitting the encrypted content, identification information for identifying the content, and transmission source terminal identification information, to a transmission destination terminal.

In another aspect of the present invention, a program for a server, directs a server to function as means for receiving an encryption key which decodes an encrypted content, identification information on the encrypted content, and identification information on a transmission source terminal transmitting the encrypted content, and identification information on a transmission destination terminal; and means for checking, when a transmission request for the encryption key is received, content identification information to be transmitted together with the transmission request for an encryption key, identification information on a transmission source terminal, and identification information on a transmission destination terminal, against identification information on the content, identification information on a transmission source terminal and identification information on a transmission destination terminal, each received, and then transmitting the encryption key when there is a match.

In the above-mentioned configurations, the server is accessed without failure when contents are distributed in a specific distribution method and the encryption key is not transmitted with contents distributed in a method other than the specific distribution method. Thus, objects of the present invention can be achieved.

### Effect of the Invention

A first effect of the present invention is that all distribution routes for contents distributed in a specific distribution method can be tracked.

The reason is that when contents are distributed in a specific distribution method, the server is certainly accessed to acquire an encryption key for communication.

A second effect of the present invention is that the content distribution route can be tracked even when contents are not reproduced.

The reason is that, in the present procedure, the server is accessed during distribution even the time period when contents are not reproduced.

A third effect of the present invention is that a content distribution system is provided capable of limiting distribution of contents to a specific distribution method.

The reason is that when contents are distributed in other methods, such as delivery of memory cards, different from a specific distribution method, the reproduction and use of contents are disapproved.

### BRIEF DESCRIPTION OF THE DRAWINGS

FIG. 1 is a block diagram illustrating a best mode configuration according to a first aspect of the present invention.

FIG. 2 is a block diagram illustrating a best mode of the server 1, according to the present invention.

FIG. 3 is a diagram illustrating a schema in a best mode of the user information database 10 according to the present invention.

FIG. 4 is a diagram illustrating a schema in a best mode of the distribution management database 18 according to the present invention.

FIG. 5 is a flowchart illustrating an operation in a best mode for carrying out the first aspect of the present invention.

FIG. 6 is a block diagram illustrating a best mode for carrying out a second aspect of the present invention.

FIG. 7 is a block diagram illustrating a best mode configuration for carrying out the invention disclosed in the patent document 1.

FIG. 8 is a block diagram illustrating a best mode configuration according to the server 1 of the invention disclosed in the patent document 1.

FIG. 9 is a diagram illustrating a schema in a best mode of the user information database 10 according to the invention disclosed in the patent document 1.

### EXPLANATION OF SYMBOLS

1 Server

2, 2a, 2b, 2c Terminal

3 Network

4 Reproduction key

5, 5′a, 5′b Encrypted contents

6, 6a, 6b, 6c User information

7, 7a, 7b, 7c Reproduction program

8, 8x, 8y Communication key

10 User information database

11 Contents database

12 Web server

13 User information manager

14 Encryption unit

15 Content distribution status analyzer

16 Distribution manager

17 Reproduction manager

18 Distribution management database

20, 20a, 20b, 20c Communication monitor

21, 21a, 21b, 21c Reproduction unit

### BEST MODE FOR CARRYING OUT THE INVENTION

In a content distribution system according to the present invention, the server encrypts contents primarily and then transmits such encrypted contents. When the contents are distributed between terminals, a transmission source terminal registers an encryption key for communication encryption in the server and then transmits the contents secondarily encrypted with the encryption key to a transmission destination terminal. When the transmission destination terminal accesses the server to obtain an encryption key from the server, the server saves a content distribution route. Moreover, each terminal accesses the server in reproduction of the content. When the server checks that the content has been distributed to the corresponding terminal, it issues a content reproduction key.

A first embodiment of the present invention will be explained below in detail by referring to attached drawings.

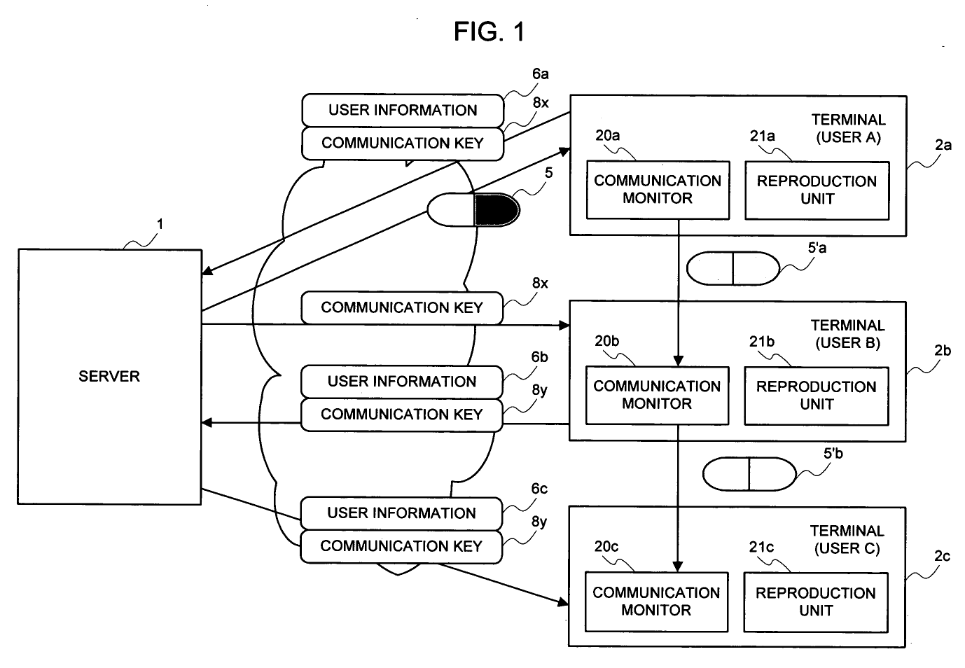

Referring to FIG. 1, the first embodiment includes a server 1 and terminals 2 (represented with numerals 2a, 2b, and 2c in FIG. 1 and each having the same function), operated under program control.

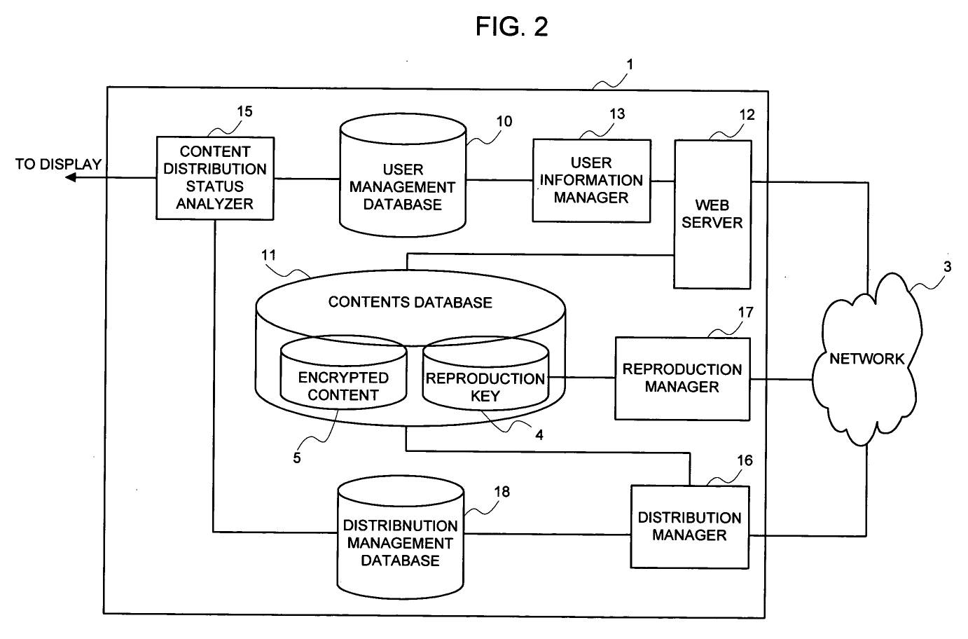

The server 1, as shown in FIG. 2, includes a user information database 10, a content database 11, a web server 12, a user information manager 13, a content distribution information analyzer 15, a distribution manager 16, a reproduction manager 17, and a distribution management database 18.

Each terminal 2 includes a communication monitor 20 (represented in numerals 20a, 20b and 20c in FIG. 1 and each having the same function) and a reproduction unit 21 (represented in numerals 21a, 21b and 21c in FIG. 1 and each having the same function).

Those means generally operate as follows:

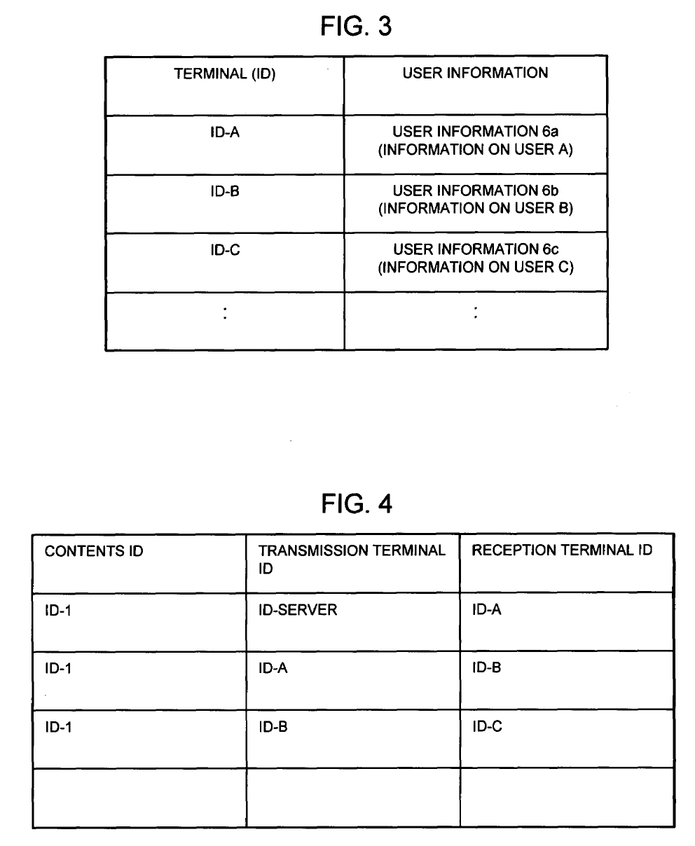

The user information database 10 stores an ID (terminal ID) for specifying a terminal and information (user information) regarding a user having a terminal, as a minimum configuration as shown in FIG. 3. A terminal ID that can uniquely compute to each terminal using a encoding string such as serial number, IP address, MAC address, or hash values for them may be used as the terminal ID. Alternatively, an ID uniquely allocated to the communication monitor or reproduction unit in each terminal may be used as the terminal ID. The user information may include user property information such as name, age, address, contact address, bath date, and vocation, and preference information, other than the user ID.

The content database 11 stores, as a minimum configuration, an encryption content 5 for having a content ID acting as a key and a reproduction key 4 for decoding the encryption content 5. If necessary, use right information for reproducing contents may be added in response to a request from the content provider. Moreover, when a reproduction key 4 or a reproduction key 4 to which use right information is added is sold, the corresponding price may be added if necessary. The content ID may be a content specifying ID uniquely allocated to a content and may be allocated to each content by means of the server 1. The content ID may be worked out from hash values of data of the encryption content 5. In addition to content encrypted data, the encryption content 5 may add URL for access to the server 1, copyright information about an author, or a content ID if the server allocates the content ID.

As shown in FIG. 4, the distribution management database 18 stores as a minimum configuration a content ID, a terminal ID (transmission terminal ID), which has been transmitted contents, and a terminal ID (a receiving terminal ID), which has been received. The distribution management database 18 may further include status information and transmission/reception time, as to the success or failure of transmission/reception.

The user information manager 13 registers and deletes data in the user information database 10.

The web server 12 performs communications of information regarding registration/deletion of user information and registers encrypted contents, a reproduction key, and, if necessary, use condition information, from a content provider.

When the terminal 2 requires an encrypted content, the distribution manager 16 transmits the encrypted content while it save information including an content ID, a transmission terminal ID, and a reception terminal ID. Moreover, the distribution manager 16 temporarily saves a communication key 8 (for convenience of explanation, represented with numerals 8x and 8y and in the same data format in FIG. 1) of One Time to be transmitted from the communication monitor 20 of the terminal 2 till the communication monitor 20 in the content reception terminal requires the communication key 8. The distribution manager 16 saves information such as the content ID, the transmission terminal ID, and the reception terminal ID to the distribution management database at the time the communication key 8 has been transmitted or erroneously transmitted to the communication monitor 20 in the content reception terminal. The One Time communication key represents a communication key of which the content changes every time.

When the reproduction unit 21 in the terminal 2 has requested the reproduction key 4, the reproduction manager 17 verifies whether or not the terminal corresponds to a terminal registered in the distribution management database. If yes, the reproduction manager 17 transmits the reproduction key 4. When the use condition information is added to the content, the reproduction manager 17 sends to the reproduction unit 21 in the terminal 2, with use condition information added to the reproduction key 4.

In the terminal to terminal content communication, the communication monitor 20 on the transmission side creates the One Time communication key 8, registers it in the distribution manager 16, doubly encrypts the encrypted content 5 with the communication key 8 (as shown with numerals 5′a and 5′b in FIG. 1), and then transmits the doubly encrypted content. The communication monitor 20 on the reception side requests the distribution manager 16 for the communication key 8 and decodes the doubly encrypted content when the communication key 8 returns. In explanation, the present embodiment includes the communication monitor 20. The communication monitor 20 may not be configured in some cases.

In the reproduction of the encrypted content 5, the reproduction unit 21 requests the reproduction manager 17 for the reproduction key 4 and decodes and reproduces the encrypted content 5 when the reproduction key 4 is returned. When the use condition information is obtained in the reception of the reproduction key 4, the reproduction unit 21 reproduces the content under the use condition. The reproduction unit 21 may be previously installed into the terminal 2 or may be downloaded from the server 1 in the reproduction of the content.

The content distribution status analyzer 15 retrieves the user which distributes a lot of contents, the user which receives the contents but does not reproduce them, the user which contributes to distribution in the P2P network, or the like, based on table information in the user information database 10 and table information in the distribution management database 18.

Next, the whole operation of the present embodiment will be explained below in detail referring to FIGS. 1, 2, and 5.

First, the content provider registers the encrypted content 5, the reproduction key 4 thereof and, if necessary, the use condition information or the price thereof, in the content database via the web server 12. In this case, the content provider may perform encryption using its own content encryption tool. Alternatively, the server 1 may provide Web services for creation of the reproduction key 4 and content encryption, in the web server and may register the services in the content provider. The content provider may be a generally fee-based content enterpriser or a user of the terminal 2. When the content provider is the user of the terminal 2, the content ID of the encrypted content 5 may be registered from the registered content, in place of the encrypted content 5.

Next, at the initial start-up, the user enters the terminal ID (for convenience in explanation, ID-A, ID-B and ID-C are labeled to the terminals 2a, 2b and 2c in FIG. 1) and the user information 6 (for convenience in explanation, 6a, 6b, and 6c are labeled to user information of the terminals 2a, 2b and 2c in FIG. 1), via the web server 12.

The user information manager 13 inputs the input information to the user information database 10. (In this case, an example of schema of the user information database is shown in FIG. 3.)

Next, the case where the encrypted content 5 is distributed from the server 1 to the terminals 2a, 2b, and 2c will be explained below as to its operation.

First, the terminal 2a requests the distribution manager 16 to capture the encrypted content 5. The distribution manager 16 retrieves and transmits the required encrypted content 5 from the content database and records the content ID (for convenience in explanation, ID-1) transmitted to the distribution management database and the terminal ID (for convenience in explanation, ID-Server) of the server 1 acting as the transmission terminal ID, and the terminal ID (ID-A) of the terminal 2a acting as the reception terminal ID. When the terminal 2a reproduces the encrypted content, the reproduction unit 21a transmits a capture request for a reproduction key for an encrypted content having the content ID-1 and ID-A, to the reproduction manager 17.

The reproduction manager 17 accesses the distribution management database 18, confirms that the ID-A corresponds to the terminal that has been downloaded from the server, captures the reproduction key 4 corresponding to ID-1, and sends back it to the reproduction unit 21a.

The reproduction unit 21a decodes and reproduces the encrypted content 5 using the reproduction key 4.

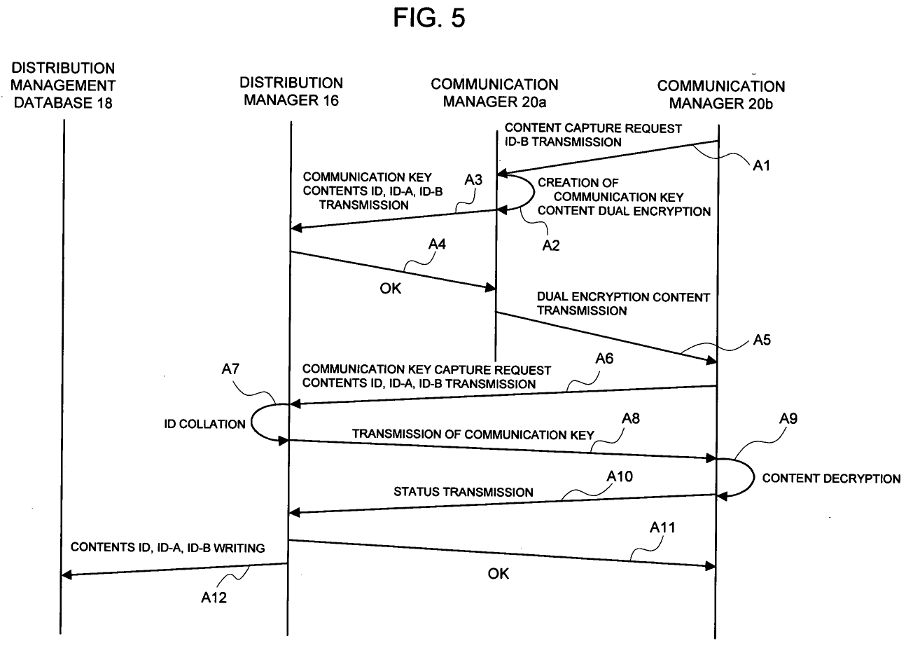

Next, the process where contents are transmitted from the terminal 2a to the terminal 2b will be explained below in detail by referring to FIG. 5.

First, the communication manager 20b in the terminal 2b transmits a capture request of the encrypted content 5 and its terminal ID (ID-B) to the terminal 2a (step A1 in FIG. 5).

Next, the communication manager 20a in the terminal 2a creates a communication key of One Time and doubly encrypts the content (step A2).

Moreover, the communication manager 20a transmits the communication key and the contents ID (ID-1), ID-A, and ID-B of the encrypted contents to the distribution manager 16 (step A3).

When the distribution manager 16 transmits the receipt confirmation to the communication manager 20a (step A4), the communication manager 20a transmits the content 5′a doubly encrypted in the step A2 to the communication manager 20b. When the terminal ID of the terminal 2a is not known at that time, the communication manager 20b transmits the content 5′a together with ID-A (step A5).

Thereafter, the communication manager 20b transmits a communication key capture request and ID-1, ID-A, and ID-B to the communication manager 16 to decode the doubly encrypted content 5′a (step A6).

The communication manager 16 verifies whether or not the content ID, transmission terminal ID, and reception terminal ID, transmitted in the steps A3 and A6, are identical (step A7) and transmits a communication key if there is a match. If not, the distribution manager 16 transmits an error message (step A8).

When having received the communication key, the communication manager 20b decodes the doubly encrypted content (step A9) and transmits the status representing the success or failure of decryption to the distribution manager 16 (step A10).

In response to the status, the distribution manager 16 transmits acknowledgement of receipt to the communication manager 20b (step All) and writes ID-1, ID-A, and ID-B to the distribution management database 18 or, if necessary, status (step A12).

Even in the case of reproducing contents, the terminal 2b performs the same process as that in the terminal 2a. Even when contents are distributed from the terminal 2b to the terminal 2c, the same process as the process of transmitting contents from the terminal 2a to the terminal 2b is performed. Thus, ID-1, ID-A and ID-B are written to the distribution management database 18 (the writing example is shown in FIG. 4).

Here, the case where encrypted content 5 (ID-1) is transmitted and received between terminals 2b and 2c via other means such as a memory card delivery will be explained below.

In this case, in the distribution management database 18, information is not written in the fourth line, as shown in FIG. 4. When the reproduction unit 21c in the terminal 2c requests a reproduction key, the reproduction manager 17 refers to the distribution management database 18. Because ID-1 is not left in the history representing that it has been transmitted to the terminal of ID-C, the reproduction manager 17 does not transmit the reproduction key 4 but transmits an error message.

Next, the effect of the present embodiment will be explained below.

In the present embodiment, when contents are distributed in a specific distribution method, the server is surely accessed to obtain an encryption key for communication. Hence, the present embodiment can track all distribution routes, which have been distributed in the specific distribution method.

Moreover, in the present embodiment, the server is accessed during the distribution time, other than the time of content reproduction. Hence, the present embodiment can track the content distribution route even when the content is not reproduced.

Finally, in the present embodiment can disapprove to use the content when the content is distributed in a method other than a specific distribution method such as a delivery of a memory card. Hence, the distribution of contents can be limited to a specific distribution method.

Next, a best mode of embedding a second aspect of the present invention will be explained below in detail by referring to the attached drawings.

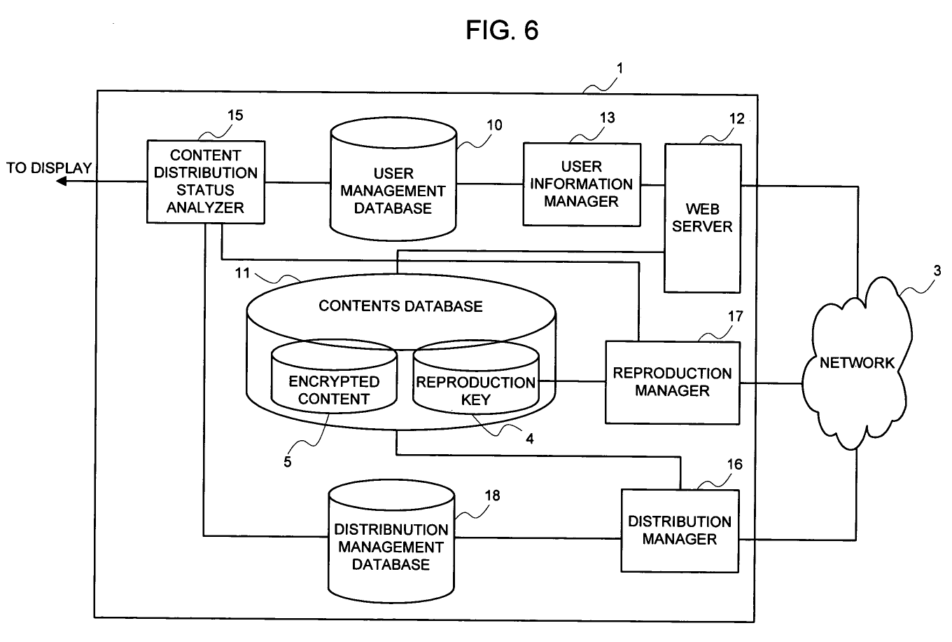

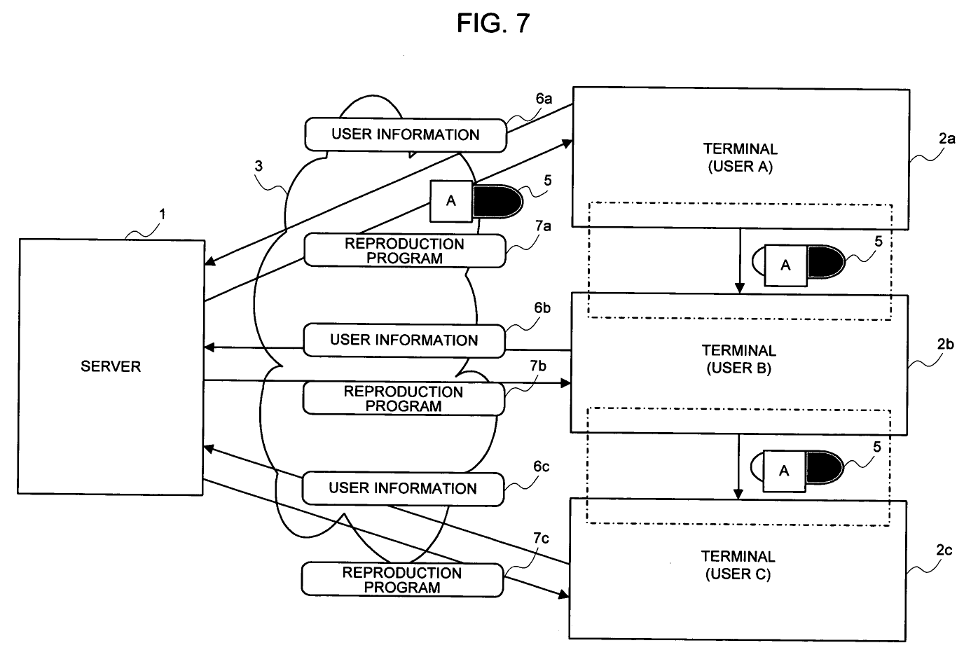

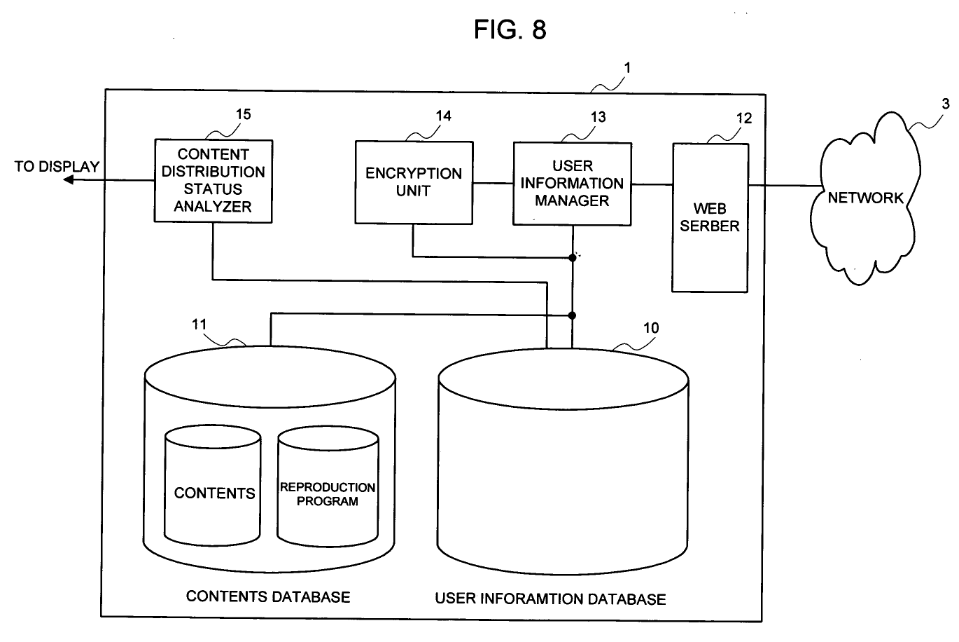

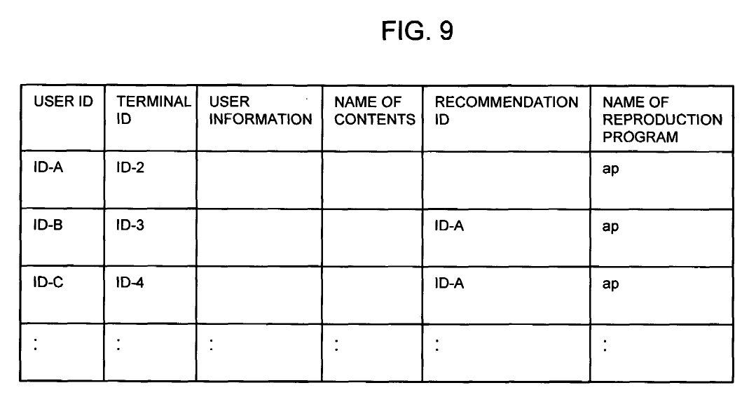

Referring to FIG. 6, the best mode of the second aspect of the present invention differs from the first aspect thereof in that the reproduction manager 17 bills before transmission of the reproduction key 4 and refers to analysis results of the content distribution status analyzer 15. Moreover, the content database 11 certainly stores the price of the reproduction key 4 or the price of the reproduction key 4 with use condition information.

An operation different from that in the first aspect of the first embodiment will be specifically explained below.

Upon receiving a capture request for the reproduction key 4 of the encrypted content 5 from the reproduction unit 20 in the terminal 2, the reproduction manager 17 performs a billing process to the user of the terminal 2 when the reproduction key 4 is available on a chargeable basis. In the billing process, the reproduction manager 17 accesses the content distribution status analyzer 15 and thus captures the number of past content distributions by the user. The billing is discounted according to the number of content distributions. Finally, when the payment of the user has completed, the reproduction manager 17 transmits the reproduction key 4 to the reproduction unit 20.

Next, the effect of the present embodiment will be explained below.

In the best mode carrying out the present embodiment, a discount process is applied to the user distributing a lot of contents when a reproduction key is distributed. For that reason, when the content distribution method between terminals utilizes the P2P software, the effect is expected that each user will maintain the power source in active state for a long time to increase the number of distributions. Thus, a stable P2P network can be configured.

The present invention is applicable to applications such as the marketing that distributes contents via the P2P network and collects the popularity stakes thereof.

Moreover, a refund or a certain incentive is added to users, which distribute a lot of contents. Thus, the present invention is applicable to applications for an increased stability of the P2P network.

1. A content distribution system comprising:
means for distributing a content encrypted;
means for saving a reproduction key for decoding said encrypted content;
means for creating an encryption key for communications when said encrypted content is transmitted and received between terminals, and for registering in a server said encryption key, an ID for said content, an ID for a transmission source terminal, and an ID for a transmission destination terminal;
means for transmitting a doubly encrypted content to said transmission destination terminal, said doubly encrypted content being obtained by doubly encrypting an encrypted content using said encryption key;
means for transmitting a transmission request after reception of said doubly encrypted content, together with said content ID and said transmission destination terminal ID, and said transmission source terminal ID, said transmission request requesting transmission of said encryption key;
means for checking said content ID, said transmission source terminal ID, and said transmission destination terminal ID, each registered, against said content ID, said transmission destination terminal ID, and said transmission source terminal ID, each transmitted together with said transmission request, and for transmitting a registered encryption key to said transmission destination terminal if there is a match;
distribution management means for saving said content ID, said transmission source terminal ID, and said transmission destination terminal ID, each registered;
means for requesting transmission of said reproduction key to reproduce said content; and
reproduction key transmission means for transmitting said reproduction key when a terminal, which has requested said reproduction key, corresponds to a terminal registered in said distribution management means.

2. The content distribution system defined in claim 1, wherein said reproduction key transmission means includes means for referring to information registered in said distribution management means and for performing discount billing in accordance with the number of distributions when a user of a terminal requesting transmission of a reproduction key has distributed a lot of contents in past.

3. A content distribution method comprising steps of:
distributing an encrypted content;
saving a reproduction key which decodes said encrypted content;
creating an encryption key for communication when said encrypted content is transmitted and received between terminals and registering in a server said encryption key and said content ID, said transmission source terminal ID, and said transmission destination terminal ID;
transmitting said doubly encrypted content, in which said encrypted content is doubly encrypted with said encryption key, from said transmission source terminal to said transmission destination terminal;
after reception of said doubly encrypted content, transmitting a transmission request for said encryption key to said server, together with said content ID, said transmission destination terminal ID, and said transmission source terminal ID;
checking said content ID, said transmission source terminal ID, and said transmission destination terminal ID, each registered, against said content ID, said transmission destination terminal ID, and said transmission source terminal ID, transmitted together with said transmission request, and then transmitting an encryption key, registered, to said transmission destination terminal when there is a match;
performing distribution management where said content ID, said transmission source terminal ID, and said transmission destination terminal ID, each registered, are saved;
requiring transmission of said reproduction key to reproduce said content; and
performing reproduction key transmission where said reproduction key is transmitted when a terminal requesting said reproduction key corresponds to a terminal registered in said distribution management means.

4. The content distribution method defined in claim 3, wherein said reproduction key transmission step comprises steps of:
referring to information registered in said distribution management step; and
performing reduction billing in accordance with the number of distributions when said reference exhibits the fact that a user of a terminal requesting transmission of a reproduction key distributed in past a lot of contents.

5. A program for directing a computer to execute the steps of:
distributing a content encrypted;
saving a reproduction key that decodes said encrypted content;
creating an encryption key for communication when said encrypted content is transmitted and received between terminals and registering to a server said encryption key, an ID for said content, an ID for a transmission source terminal, and an ID for a transmission destination terminal;
transmitting a doubly encrypted content, in which an encrypted content is doubly encrypted with said encryption key, to said transmission destination terminal;
after said doubly encryption content is received, transmitting a transmission request, which requires transmission of said encryption key together with said content ID, said transmission destination terminal ID, and said transmission source terminal ID;
checking said content ID, said transmission source terminal ID, and said transmission destination terminal ID, each registered, against said content ID, said transmission destination terminal ID, and said transmission source terminal ID, transmitted together with said transmission request and then transmitting said registered encryption key to said transmission destination terminal when there is a match;
performing a distribution management process for saving said content ID, said transmission source terminal ID, and said transmission destination terminal ID, each registered;
requiring transmission of said reproduction key to reproduce said content; and
performing a reproduction key transmission process for transmitting said reproduction key when a terminal requiring said reproduction key corresponds to a terminal registered in said distribution management means.

6. The program defined in claim 5, wherein said reproduction key transmission process directs a computer to execute the steps of:
referring to information registered in said distribution management process;
performing reduction billing according to the number of distributions when a user of a terminal requiring a reproduction key distributed in past a lot of contents.

7. A terminal comprising:
means for creating a communication key when an encrypted content is transmitted to another terminal and transmitting said communication key, an ID of an encrypted content, an ID of a transmission source terminal, and an ID of a transmission destination terminal;
means for creating a doubly encrypted content, in which an encrypted content is doubly encrypted with said communication key;
means for transmitting said doubly encrypted content;
means for receiving said doubly encrypted content;
when a transmission request for transmission of said communication key is transmitted, means for transmitting said encrypted content ID, said transmission source terminal ID, and said transmission destination terminal ID;
means receiving a communication key transmitted in accordance with a transmission request for said communication key and decoding said doubly encrypted content;
means for requiring transmission of said reproduction key to reproduce said decoded content; and
means for receiving a reproduction key transmitted in accordance with a transmission request for said reproduction key and reproducing said content.

8. A server comprising:
means for saving an ID of an encrypted content and a reproduction key to decode said encrypted content ID;
means for receiving a communication key, said encrypted content ID, a transmission source terminal ID, and a transmission destination terminal ID, from a transmission source terminal;
means for receiving a communication key transmission request, said encrypted content ID, a transmission source terminal ID, and a transmission destination terminal ID, from a transmission destination terminal;
means for subjecting said content ID, said transmission source terminal ID, and said transmission destination terminal ID, received by said two means, to verification and then transmitting said communication key to said transmission destination terminal when there is a match;
means for registering said encrypted content ID, said transmission source terminal ID and said transmission destination terminal ID in a database; and
means for verifying, when a transmission request for said reproduction key has come from a transmission destination terminal, whether or not said terminal is in said database and transmitting said reproduction key when said corresponding terminal is in said database.

9. The server defined in claim 8, wherein said reproduction key transmission means includes means for referring to information registered in said database and performing reduction billing in accordance with the number of distributions when a user of a terminal requesting a reproduction key distributed in past a lot of contents.

10. (canceled)

11. (canceled)

12. (canceled)

13. (canceled)

14. (canceled)

15. (canceled)
